(19) United States
(12) Patent Application Publication
(10) Pub. No.: US 2026/0361066 A1
(43) Pub. Date: Nov. 12, 2026

(54) GROUP OF ELECTRIC WIRES AND ELECTRIC WIRE ROUTING STRUCTURE

(71) Applicant: Yazaki Corporation, Tokyo (JP)

(72) Inventors: Eri UEDA, Shizuoka (JP); Naoto KOGURE, Shizuoka (JP)

(73) Assignee: Yazaki Corporation, Tokyo (JP)

(21) Appl. No.: 19/637,029

(22) Filed: Apr. 2, 2026

(30) Foreign Application Priority Data
May 7, 2025 (JP) 2025-077357

(51) Int. Cl. H02G 11/00; B60R 16/02; B60R 16/027

(52) U.S. Cl. CPC H02G 11/00; B60R 16/0215; B60R 16/027

(57) ABSTRACT

The electric wire routing structure 1 is a structure for routing a group of electric wires 6 to a seat 2 of an automobile. The seat 2 is rotatably supported on a base frame 4 via a rotation mechanism 3. The group of electric wires 6 includes three insulated electric wires 61, 62, and 63, with one end portion 6a and another end portion 6b being unbraided, and the portion 6c between the one end portion 6a and the another end portion 6b being braided in a three-strand braid. The one end portion 6a is fixed to the bottom surface of the seat portion 21 of the seat 2. The another end portion 6b is fixed to the base frame 4. The portion between the one end portion 6a and the another end portion 6b is movable in accordance with the rotation of the seat 2.

### TECHNICAL FIELD

The present invention relates to a group of electric wires and an electric wire routing structure.

### BACKGROUND

Conventionally, electric wires have been used to supply power to and transmit signals for electronic devices. Among these, electric wires routed to rotating or sliding electronic devices are likely to have reduced durability due to bending and similar stresses. Accordingly, various techniques have been developed to improve the durability of electric wires routed to rotating or sliding electronic devices. For example, Patent Document 1 discloses a technique in which a protective member formed by spirally winding a metal wire around the outer circumference of an electric wire is attached thereto.

### RELATED ART

### PATENT DOCUMENT

Patent Document 1: JP2021023022 A

### SUMMARY OF THE INVENTION

### PROBLEM TO BE SOLVED BY THE INVENTION

In configurations in which a protective member is attached to an electric wire as in the Patent Document 1 described above, there have been problems such as increased component costs and increased weight.

Accordingly, it is an object of the present invention to provide a structure capable of enhancing the durability of electric wires without using a protective member.

### SOLUTION TO PROBLEM

The present invention relates to a group of electric wires comprising three or more insulated electric wires, wherein the three or more insulated electric wires include a braided portion.

The present invention also relates to an electric wire routing structure for a rotating body rotatably supported by a base frame, including the group of electric wires, wherein one end portion of the group of electric wires is fixed to the rotating body, another end portion of the group of electric wires is fixed to the base frame, and a portion between the one end portion and the another end portion of the group of electric wires is not fixed, and is configured to be movable in accordance with the rotating body.

### ADVANTAGEOUS EFFECTS OF THE INVENTION

According to the present invention, the durability of electric wires can be enhanced without using a protective member.

### BRIEF DESCRIPTION OF THE DRAWINGS

FIGS. 1A and 1B are diagrams illustrating an electric wire routing structure according to an embodiment of the present invention, in which FIG. 1A is a top view and FIG. 1B is a side view.

FIGS. 2A and 2B are views illustrating the seat illustrated in FIGS. 1A and 1B are rotated 180 degrees, wherein FIG. 2A is a top view and FIG. 2B is a side view.

FIG. 3 is a view illustrating a group of electric wires provided in the electric wire routing structure of FIG. 1.

FIG. 4 is a view illustrating a state in which the group of electric wires of FIG. 3 is bent.

### DETAILED DESCRIPTION OF THE EXEMPLARY EMBODIMENT

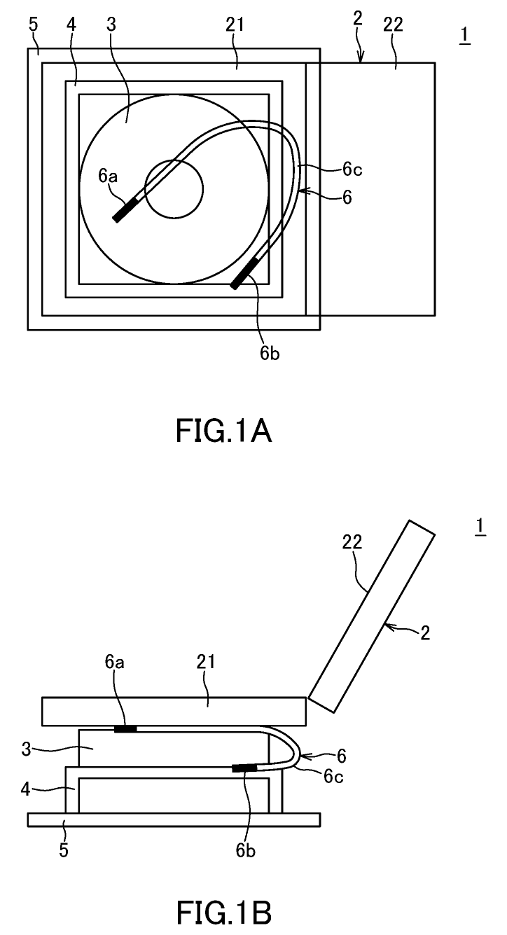

A group of electric wires and an electric wire routing structure according to an embodiment of the present invention will be described with reference to FIGS. 1-4.

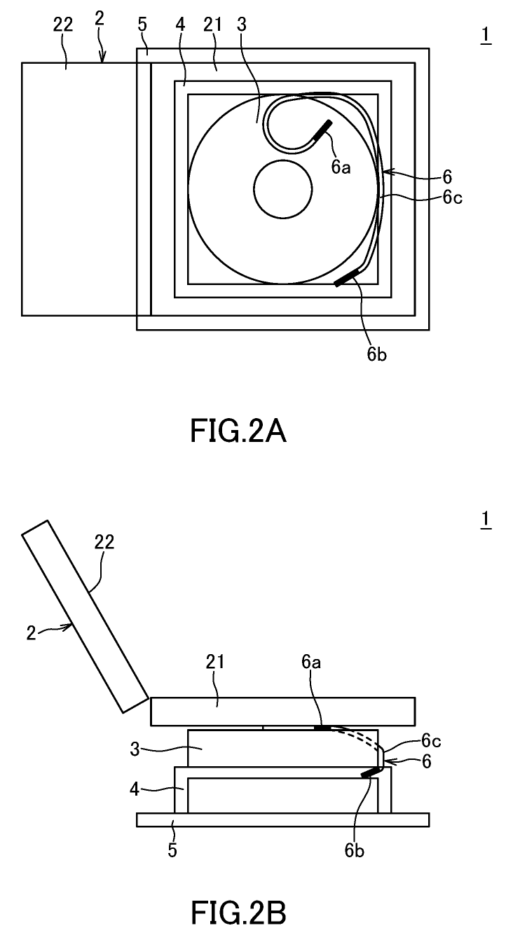

The electric wire routing structure 1 illustrated in FIGS. 1A, 1B, 2A, and 2B is a structure for routing a group of electric wires 6 to a vehicle seat (corresponding to a “rotating body”) 2.

The seat 2 includes a seat portion 21 and a seatback 22. Electrical components are provided inside the seat portion 21 and the seatback 22, and a wire harness is routed therein. The electrical components include, for example, an electric reclining mechanism and a heater. The wire harness includes a plurality of electric wires connected to the electrical components and connectors attached to terminals of the plurality of electric wires. The connector of the wire harness is connected, at a bottom surface of the seat portion 21, to a connector attached to one end portion 6a of the group of electric wires 6.

A base frame 4 and a rotation mechanism 3 are provided between the seat portion 21 of the seat 2 and the floor carpet 5. The rotation mechanism 3 is mounted on an upper surface of the base frame 4, and the seat portion 21 is mounted on an upper surface of the rotation mechanism 3. The base frame 4 does not rotate, and the rotation mechanism 3 is rotatable relative to the base frame 4 together with the seat 2. In this manner, the seat 2 is rotatably supported by the base frame 4 via the rotation mechanism 3. As illustrated in FIGS. 1A, 1B, 2A, and 2B, the seat 2 is provided so as to be rotatable by 180 degrees.

The group of electric wires 6 is a group of electric wires including three or more insulated electric wires, and includes a braided portion in which the three or more insulated electric wires are braided together, and a non-braided portion in which they are not braided. In the braided portion, all of the electric wires constituting the group of electric wires 6 are braided together. The group of electric wires 6 is not covered with a separate member such as a sheath or a corrugated tube, and its rigidity is increased solely by braiding the insulated electric wires. Moreover, the rigidity can be further enhanced by reducing the braiding pitch of the insulated electric wires (i.e., by braiding them more tightly).

In the present specification, the expression “braiding three or more insulated electric wires” means repeatedly passing one insulated electric wire between another insulated electric wire and still another insulated electric wire so as to collectively interweave the plurality of insulated electric wires into a single bundle, and does not mean twisting them together.

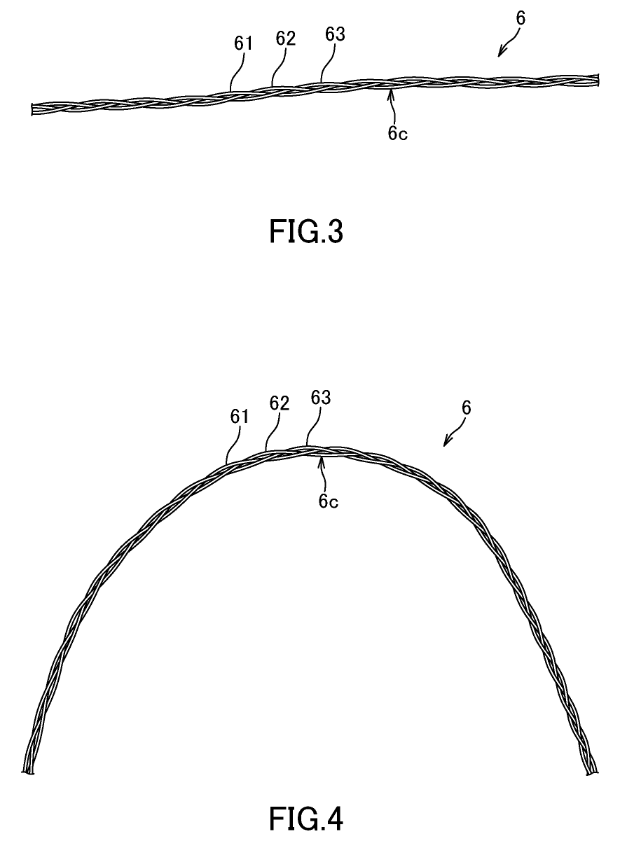

In this example, as illustrated in FIGS. 3 and 4, the group of electric wires 6 is composed of three insulated electric wires 61, 62, and 63. The group of electric wires 6 has one end portion 6a and another end portion 6b (illustrated in FIGS. 1A, 1B, 2A, and 2B), that are not braided, and a middle portion 6c (shown in FIGS. 3 and 4) between the one end portion 6a and the another end portion 6b that is braided in a three-strand braid. Connectors are attached to both the one end portion 6a and the another end portion 6b of the group of electric wires 6. Each connector includes terminals connected to the cores of the insulated electric wires 61, 62, and 63, and a resin housing accommodating these terminals.

As illustrated in FIGS. 1A, 1B, 2A, and 2B, the one end portion 6a of the group of electric wires 6 is fixed to the bottom surface of the seat portion 21. At the bottom surface of the seat portion 21, the connector attached to the one end portion 6a of the group of electric wires 6 is connected to a connector of a wire harness routed inside the seat 2. The another end portion 6b of the group of electric wires 6 is fixed to the upper surface of the base frame 4. On the upper surface of the base frame 4, the connector attached to the another end portion 6b of the group of electric wires 6 is connected to a connector of a wire harness routed on the vehicle floor. The middle portion 6c of the group of electric wires 6, located between the one end portion 6a and the another end portion 6b, is not fixed and extends along the outer surface of the rotation mechanism 3. This middle portion 6c is configured to move in accordance with the rotation of the seat 2.

Thus, the electric wire routing structure 1 is configured to route the group of electric wires 6 to the rotating seat 2, and the portion 6c of the group of electric wires 6 that follows the seat 2 is braided to increase rigidity, making it less prone to bending (i.e., increasing the bending radius) and thereby improving bending durability. In addition, the group of electric wires 6 achieves enhanced rigidity solely by braiding the insulated electric wires 61, 62, and 63, without being covered by any additional member, which reduces component costs and avoids an increase in weight.

In the above-described embodiment, the group of electric wires is composed of three insulated electric wires; however, in the present invention, the group of electric wires may be composed of four or more insulated electric wires. When the group of electric wires is composed of four insulated electric wires, the group of electric wires may be braided in a four-strand braid. When the group of electric wires is composed of six insulated electric wires, the group of electric wires may be braided in a three-strand braid using two electric wires per strand. A three-strand braid of which some strands are composed of one electric wire and some strands are composed of two electric wires may be used. Thus, in the present invention, the group of electric wires is composed of three or more insulated electric wires and only needs to include a braided portion.

In the above-described embodiment, the structure for routing the aforementioned group of electric wires to the rotating seat has been described; however, the rotating body of the present invention is not limited to a seat. Also, the group of electric wires of the present invention is also suitably used for a routing structure for a sliding body, not limited to a rotating body.

It should be noted that the above-described embodiment merely illustrates a typical form of the present invention, and the present invention is not limited to this embodiment. That is, the present invention can be implemented with various modifications without departing from the gist of the invention. It is to be understood that as long as such modifications still include the configuration of the present invention, such modifications are encompassed within the scope of the present invention.

### LIST OF REFERENCE SIGNS

1 electric wire routing structure
2 seat (rotating body)
3 rotation mechanism
4 base frame
6 group of electric wires
61, 62, 63 insulated electric wire

1. A group of electric wires comprising three or more insulated electric wires,
wherein the three or more insulated electric wires include a braided portion.

2. The group of electric wires according to claim 1, wherein one end portion and another end portion of the three or more insulated electric wires are not braided, and
a portion between the one end portion and the another end portion is braided.

3. An electric wire routing structure for a rotating body rotatably supported by a base frame, comprising:
the group of electric wires according to claim 1,
wherein one end portion of the group of electric wires is fixed to the rotating body,
another end portion of the group of electric wires is fixed to the base frame, and
a portion between the one end portion and the another end portion of the group of electric wires is not fixed, and is configured to be movable in accordance with the rotating body.

4. An electric wire routing structure for a rotating body rotatably supported by a base frame, comprising:
the group of electric wires according to claim 2,
wherein one end portion of the group of electric wires is fixed to the rotating body,
another end portion of the group of electric wires is fixed to the base frame, and
a portion between the one end portion and the another end portion of the group of electric wires is not fixed, and is configured to be movable in accordance with the rotating body.
